(19) United States
(12) Patent Application Publication
(10) Pub. No.: US 2014/0358614 A1
(43) Pub. Date: Dec. 4, 2014

(54) CALENDAR-AGNOSTIC MEETING SCHEDULING

(71) Applicant: VivaJiva, LLC, Irving, TX (US)

(72) Inventors: Rajan Grover, Irving, TX (US); Jasbir Singh, Summerfield, NC (US)

(21) Appl. No.: 14/294,741

(22) Filed: Jun. 3, 2014

Related U.S. Application Data
(60) Provisional application No. 61/830,276, filed on Jun. 3, 2013.

(51) Int. Cl. G06Q 10/10

(52) U.S. Cl. CPC G06Q 10/1095
USPC 705/7.19

(57) ABSTRACT

Disclosed are various embodiments for a calendar-agnostic scheduling application. The scheduling application may communicate a request for availability to other instances of the scheduling application. The scheduling application may determine availability according to a query in the request for availability by applying the query to a calendar accessible via a calendar provider. Meetings may be scheduled according to the availability of users determined by the queries while maintaining agnosticism to the calendar providers of the users.

### CROSS REFERENCE TO RELATED APPLICATIONS

This application claims priority to co-pending U.S. provisional application entitled “CALENDAR-AGNOSTIC MEETING SCHEDULING” having Ser. No. 61/830,276, filed Jun. 3, 2013, the entirety of which is hereby incorporated by reference.

### BACKGROUND

Users may manage their personal calendars using a variety of calendar providers. This can create complications in attempting to determine each other's availability across incompatible calendar providers. This problem is accentuated when a user attempts to schedule meetings among groups of individuals and/or at multiple venues from multiple entities on disparate email and calendar providers. Additionally, arranging meetings between users who use different calendar providers may be impaired due to various incompatibilities.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a flowchart illustrating one example of functionality implemented as portions of a scheduling application executed in a client device according to various embodiments of the present disclosure.

FIGS. 2-12 are drawings of an example of a user interface rendered by a client device executing the scheduling application according to various embodiments of the present disclosure.

FIG. 13 is a schematic block diagram that provides one example illustration of a computing device executing the scheduling application according to various embodiments of the present disclosure.

### SUMMARY

Disclosed are various embodiments for a calendar-agnostic scheduling application.

In one embodiment, a user may execute the scheduling application in a client comprising, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client may include a display comprising, for example, one or more devices such as liquid crystal display (LCD) displays, gas plasma-based flat panel displays, organic light emitting diode (OLED) displays, LCD projectors, or other types of display devices, etc.

The client may be further configured to access one or more calendars associated with the client which are managed by a variety of calendar providers. Examples of calendar providers may include, for example, Google Calendars™, iCal™, Microsoft Exchanger™, as well as other calendar providers as can be appreciated. The client may access the one or more calendars via a dedicated application, web service, Application Program Interface, or by another approach.

In some embodiments, the scheduling application may be configured to schedule a meeting with one or more other users also executing instances of the scheduling application. This may comprise first determining an availability of a user associated with the client who is requesting the meeting. Determining the availability of a user requesting the meeting may comprise accessing the one or more calendars associated with the client. This may be facilitated by accessing data stored in the client, communicating with a server or computing environment associated with the calendar provider of the calendar, or by another approach.

After accessing the calendar, the scheduling application may then determine periods of availability during a time period embodied in a query applied to the calendar. The query may define temporal parameters such as a start date, end date, time windows during one or more days, or other parameters. Furthermore, the query may comprise a duration of consecutive availability required for the meeting. For example, the query may comprise a request to determine thirty-minute periods of availability during a period of one week, where the periods are to be between 9:00 am and 5:00 pm.

The temporal parameters of the query may be input by a user, be generated as a function of user preferences, or be generated by another approach. Additionally, the query may be selected from a predefined list of queries, selected from a history of previously generated queries, or selected by another approach. Queries may be stored in the client, in a networked location accessible to the client, or by another approach. Furthermore, the queries may be stored in a standardized format such as Extensible Markup Language (XML) or comma separated values (CSV), in a proprietary or custom data format, or in other formats as can be appreciated.

In some embodiments, the scheduling application may be further configured to obtain periods of availability from other users invited in the meeting request. The periods of availability may be obtained from an account management server accessible via a network, obtained responsive to a request communicated to a respective invited user, or by another approach.

In embodiments in which a period of availability is shared between users, the scheduling application may filter or conceal certain attributes of a user calendar. For example, if a user is sharing their periods of availability with another user, the periods of availability may indicate periods during which a user has a scheduled task or is otherwise occupied, but the scheduling application may filter the location of the user or the task being performed at that time. This limits the periods of availability to only indicating available time, without otherwise exposing private or personal data of a user.

After determining periods of availability for the user and potentially other users, the user may then select one or more of the periods of availability for a meeting request. The client may then communicate the meeting request to one or more users. The users may be identified by an email address, phone number, account username, or by another approach.

In other embodiments, the user may communicate the meeting request as including the temporal parameters for the availability query as described above, allowing a recipient to select one or more blocks of time within the temporal parameters according to their respective availability. For example, a user may communicate a meeting request to an attendee requesting a meeting time for one hour between 8:00 and 5:00 on Monday, Wednesday, or Friday. The attendee may then reply to the meeting request by accepting and indicating a block of time within the temporal parameters in which they are available, denying the meeting request, or performing another action.

The meeting request may be communicated to the identified users via an email message, Short Message System (SMS) message, push notification, or by another approach. A recipient user also executing an instance of the scheduling application may then access the message embodying the meeting request to begin a reply process. In some embodiments, the meeting request may identify a user who is not executing an instance of the scheduling application or who does not have a user account associated with the scheduling application. In such an embodiment, the meeting request may comprise a link or other message soliciting the user to download, purchase, or otherwise obtain an instance of the scheduling application to allow the user to reply to the meeting request. The meeting request may further comprise a solicitation to register an account with an account management server or other functionality facilitating the management of user accounts for the scheduling application. For example, the meeting request may comprise a link to an application distribution service or network site from which the scheduling application may be obtained.

In some embodiments, the scheduling application may require that a meeting request be sent to users who have explicitly agreed to receive meeting requests from the sender. This may comprise, for example, requiring users to be included in respective contact lists, social media networks, or other relationship models prior to communicating a meeting request. In such an embodiment, the scheduling application may notify a user that a recipient of the meeting request is not included in the requisite relationship model. The scheduling application may further prompt the user to communicate a request to the user to establish the requisite relationship prior to or in conjunction with the meeting request.

A client executing the scheduling application who receives a meeting request may then input a reply to the meeting request to be communicated to the originator of the meeting request and other recipients of the meeting request. A reply may comprise, for example, an acceptance of the meeting request. In embodiments in which the meeting request comprises multiple periods of availability of a sender, the reply may comprise a selection of one of the periods of availability for which the user accepts the meeting. Responsive to an acceptance of the meeting, the scheduling application may then modify a calendar associated with the accepting user.

In other embodiments, the reply may comprise declining the meeting. Furthermore, a reply declining the meeting may comprise an indication of the denying user's availability as was set forth above with respect to the availability of the user sending the meeting request. By including an indication of the denying user's availability in the reply, the sender of the meeting request may select a different time for the meeting.

In one or more embodiments, the meeting venue may itself be registered either as a client for the collaborative meetings, or as a calendar of its own. Within the calendar and device agnostic framework of the application, the client or shared calendar may be setup in any of the multitude device categories or calendar-providers.

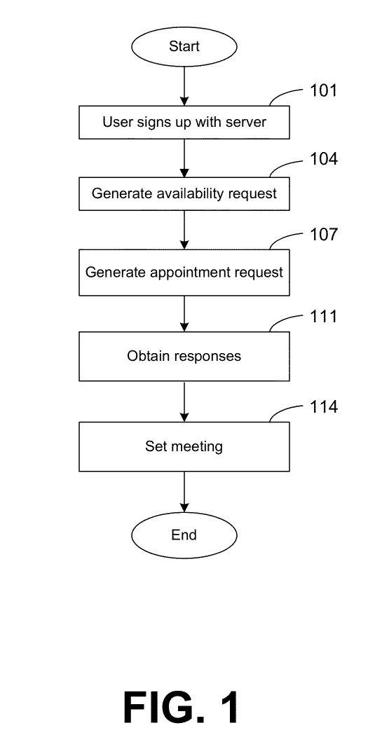

Referring next to FIG. 1, shown is a flowchart that provides one example of the operation of a portion of the scheduling application according to various embodiments. It is understood that the flowchart of FIG. 1 provides merely an example of the many different types of functional arrangements that may be employed to implement the operation of the portion of the scheduling application as described herein. As an alternative, the flowchart of FIG. 1 may be viewed as depicting an example of steps of a method implemented in the computing device such as a client according to one or more embodiments.

Beginning with box 101, a user of a client signs up with an account server associated with the scheduling application. This may comprise a user registration process. For example it may comprise creating a username, password, or other authentication credentials associated with the user account. In embodiments in which an email is associated with a user account, this may comprise comparing the input email to an email account registered on the client device, such as with an email application. In some embodiments, the scheduling application may restrict interactions with the scheduling application to registered client devices. In such an embodiment, signing up may comprise registering the client as one or more registered devices of the user account.

Next, in box 104, the user of a client generates an availability request to determine periods of availability for the user and one or more additional users. This may comprise applying a query to a calendar accessible to the client. This may further comprise sharing the periods of availability of the user of the client to other users in exchange for their periods of availability. In some embodiments, this comprises filtering or masking the activities scheduled in the calendar to only expose time periods during which a respective user is occupied, and conceal the activities and locations of the user during those periods of activity.

In box 107, the scheduling application then generates a meeting request to one or more other users based on the periods of availability requested in box 104. In some embodiments, the scheduling application may determine if the recipients have registered accounts with the account server. In such an embodiment, the meeting request may comprise an invitation to download the scheduling application and register an account with the account server.

In box 111, the scheduling application obtains responses to the meeting request from the users. A response may comprise accepting the meeting, declining the meeting, deferring to respond until later, requesting another reminder at a later date, or other responses.

After obtaining the responses, the scheduling application then sets the meeting in box 114. Setting the meeting may be based in part on a required number of accepting attendees, a quorum of attendees, the acceptance of necessary parties, or other criteria. Setting the meeting may comprise accessing a calendar accessible to the client via an application program interface, web service, by modifying calendar data stored in the client, or by another approach.

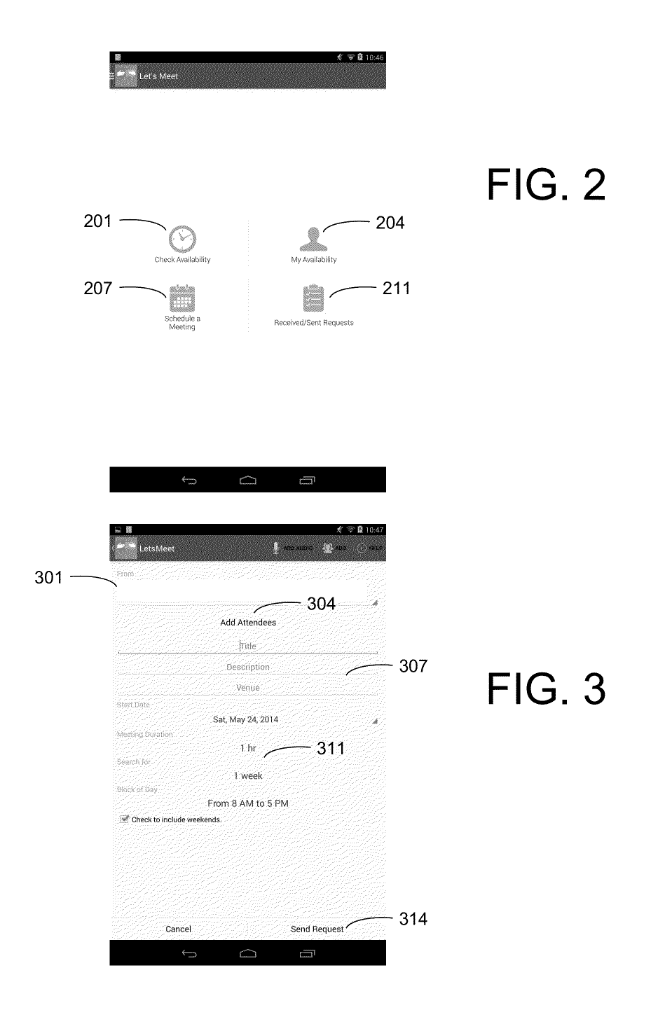

Moving on to FIG. 2, shown is an example user interface encoded for rendering by a client to facilitate a selection of various functionality associated with the scheduling application. The user interface of FIG. 2 may be encoded for rendering as a dedicated menu, as a subcomponent of another menu, or by another approach. Item 201 is an icon input that, when selected, initiates functionality to check the availability of other users of the scheduling application. Item 204 is an icon input that, when selected, initiates functionality to display the availability of a user of the currently executing instance of the scheduling application. Item 207 is an icon input that, when selected, initiates functionality to schedule a meeting via the scheduling application. Item 211 is an icon input that, when selected, initiates a display of sent and/or received requests of the scheduling application.

Turning next to FIG. 3, shown is an example user interface encoded for rendering by a client to schedule a meeting of a defined duration at a point within a defined time window as determined by the availability of various attendees. Item 301 is a display field showing who will be listed as an organizer or originator of the meeting. Item 304 is a button input that, when selected, initiates the addition of one or more attendees to the meeting. Item 307 corresponds to various input fields to input attributes for the meeting, such as a title, description, and venue. Item 311 corresponds to various input fields to define temporal parameters of the meeting, such as a start date, a meeting duration, a period for searching availability, and a block of time during the day to search availability. The temporal parameters of item 311 will then be accessed by the attendees and compared to their respective availabilities to determine a time for scheduling the meeting. Item 314 is a button that, when clicked, communicates a meeting request to the attendees added via item 304.

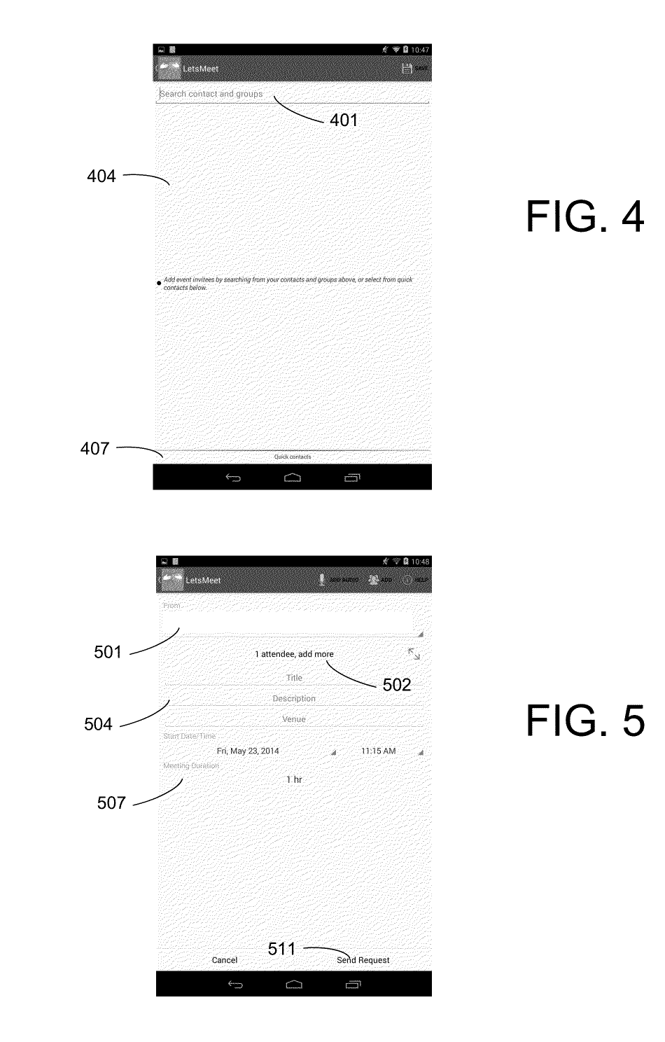

Referring next to FIG. 4, shown is an example user interface encoded for rendering by a client to search for attendees for addition to a meeting request. Item 401 is an input for one or more parameters to search for an attendee. Such inputs may include, for example, identifying data such as a name, contact data such as an email address, phone number, Uniform Resource Locator (URL), or other data. The input to item 401 may then be used to search various repositories for the contact. Such repositories may include, for example, contact lists stored locally on a client or stored remotely. Such repositories may also include social media networks accessible to the user of the client executing the scheduling application. The scheduling application will look for consecutive amounts of available time meeting or exceeding the meeting duration indicated in item 401 in determining periods of availability. Item 404 is a display area for listing already added attendees to the meeting request. Item 407 is a button that, when clicked, accesses a grouping of attendees selected according to predefined criteria. Such a grouping may include, for example, most frequently selected attendees, most recently added attendees, or other groupings. If desired a separate user interface or page may be included to search contacts and/or to display contact groups.

Moving on to FIG. 5, shown is an example user interface encoded for rendering by a client to schedule a meeting of a defined duration at a predefined start time according to various embodiments. Item 501 is a display field showing who will be listed as an organizer or originator of the meeting. Item 502 is a button input that, when selected, initiates the addition of one or more attendees to the meeting. Item 504 corresponds to various input fields to input attributes for the meeting, such as a title, description, and venue. Item 507 corresponds to various input fields to define temporal parameters of the meeting, such as a start date and time and a meeting duration. Item 511 is a button that, when clicked, communicates a meeting request to the attendees added via item 502.

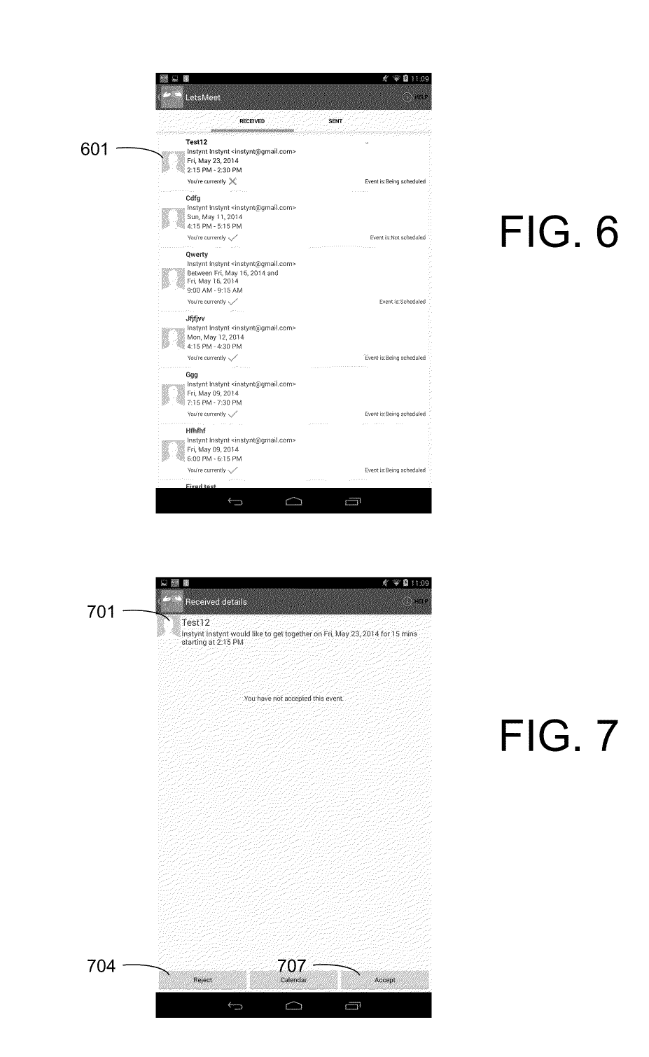

Referring next to FIG. 6, shown is an example user interface encoded for rendering by a client to list received meeting requests from other users of the scheduling application. Item 601 is one of a list of entries each corresponding to a received meeting request. Within the entry indicated by item 601 are various attributes of a meeting request, including a user sending the request, temporal parameters defining the constraints of the meeting request, whether or not a user of the scheduling application is available during the temporal parameters of the meeting request, and whether the meeting for the meeting request is currently being scheduled or has been scheduled. Other attributes may also be encoded in the entry indicated by item 601 as can be appreciated.

Turning next to FIG. 7, shown is an example user interface encoded for rendering by a client to display details of a selected received meeting request. The user interface of FIG. 7 may be rendered, for example, in response to selecting a received meeting request from a list of received meeting requests (see FIG. 6). Item 701 is a display field displaying various attributes of a received meeting request. These attributes may correspond to those attributes displayed in a corresponding entry in a list of received meeting requests as shown in item 601 (FIG. 6), or additional details. Item 704 is a button that, when selected, rejects the request to attend the meeting indicated in the meeting request. Item 707 is a button that, when selected, accepts the request to attend the meeting indicated in the meeting request. A button may also be included to allow the user to save the meeting to a calendar, and if desired a separate user interface page may be included for this purpose and to select among multiple calendars if the user maintains more than one calendar.

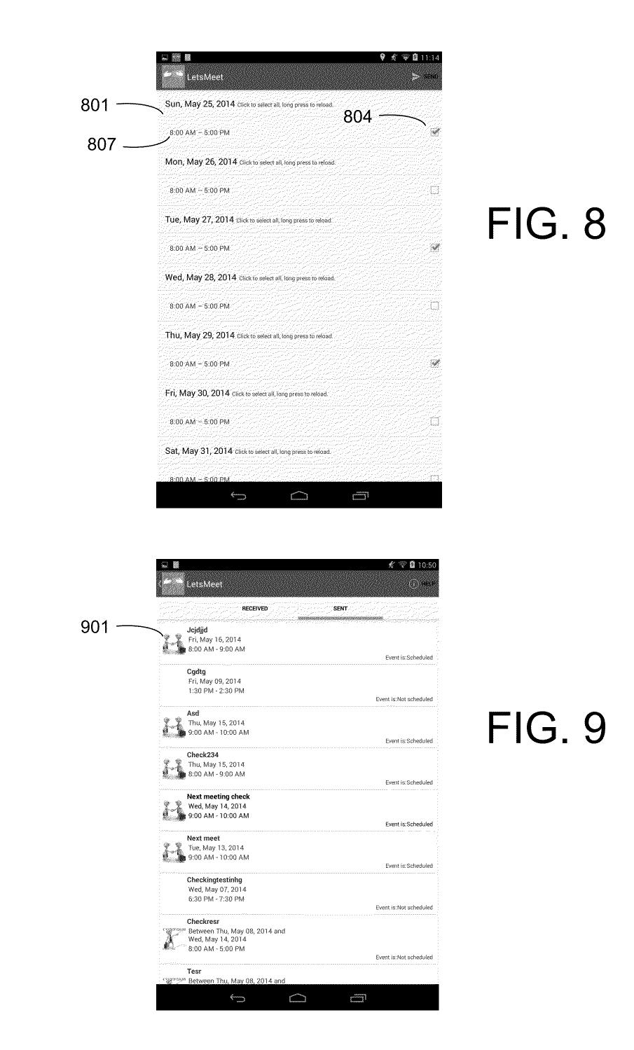

Moving on to FIG. 8, shown is an example user interface encoded for rendering by a client to configure the availability of a user for various days. Item 801 is one of a list of entries each corresponding to a respective day of the week. Included in the entry indicated by item 801 is a check box input indicated by item 804 that, when selected, indicates that the user is available on the respective day. Also included in the entry indicated by item 801 is a time window for the respective day indicated by item 807 during which the user will be indicated as available, unless contradicted by a scheduled meeting or other criteria.

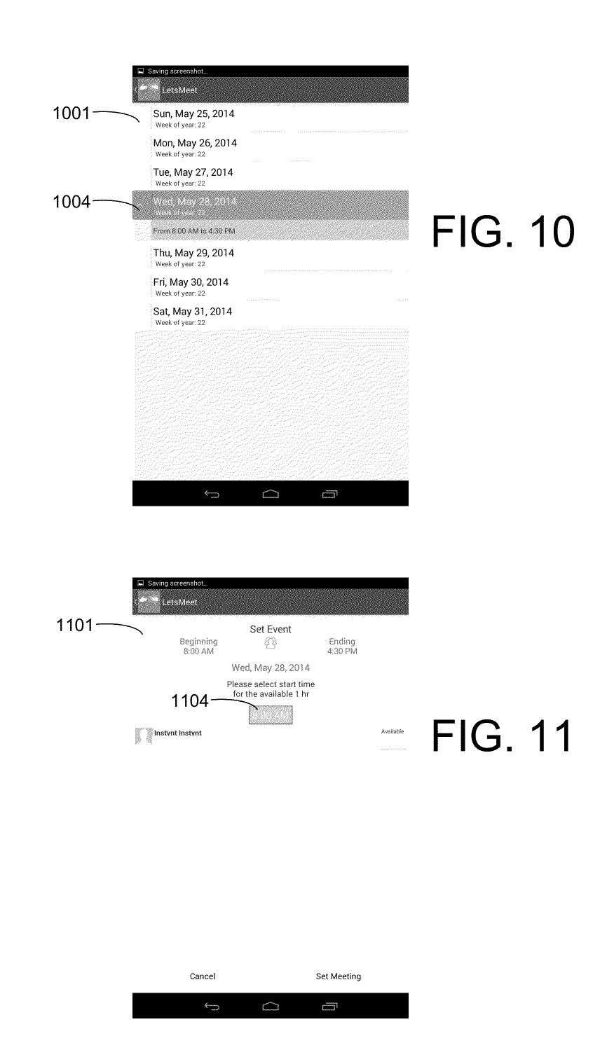

Referring next to FIG. 9, shown is an example user interface encoded for rendering by a client to list received meeting requests from other users of the scheduling application. Item 901 is one of a list of entries each corresponding to a received meeting request. Within the entry indicated by item 901 are various attributes of a meeting request, including temporal parameters defining the constraints of the meeting request and whether the meeting for the meeting request is currently being scheduled or has been scheduled. Other attributes may also be encoded in the entry indicated by item 901 as can be appreciated.

Turning now to FIG. 10, shown is an example user interface encoded for rendering by a client to facilitate the selection of a time slot within a day to schedule a meeting for a received meeting request. Item 1001 is a list of entries each corresponding to a respective day of the week within the time window defined by a meeting request. Item 1004 is a selected entry in the list, which further displays a time window for the respective day during which a meeting may be scheduled according to the constraints of the meeting request.

Moving on to FIG. 11, shown is an example user interface encoded for rendering by a client to facilitate the selection of a block of time for scheduling a meeting in a day selected by the user interface of FIG. 10. Item 1101 displays the constraints of a time window for selecting a block of time. In this example, the time window is from 8:00 am to 4:30 pm, and a user is to select a start time for a one hour block of time. Item 1104 is an input field to input the start time for the block of time to set the meeting.

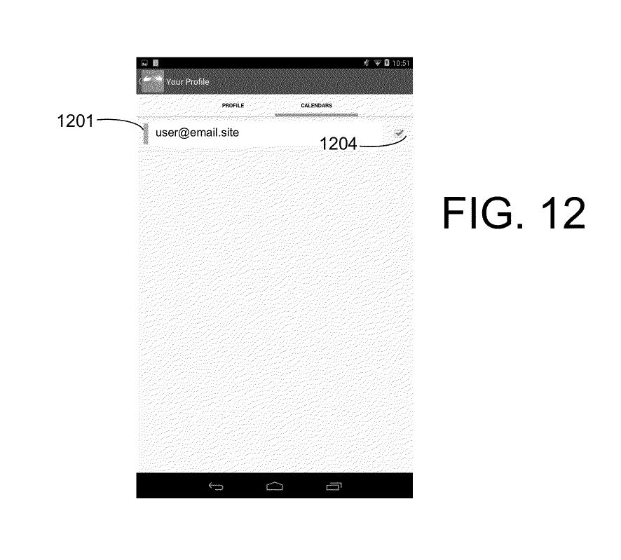

Referring next to FIG. 12, shown is an example user interface encoded for rendering by a client to configure the accessibility of various calendar providers to the scheduling application. Item 1201 is an entry in a list corresponding to a calendar provider associated with a user of the scheduling application. Item 1204 is a check box input that, when selected, indicates that the corresponding calendar provider should be accessed by the scheduling application to determine availability, record meetings, or perform other functionality.

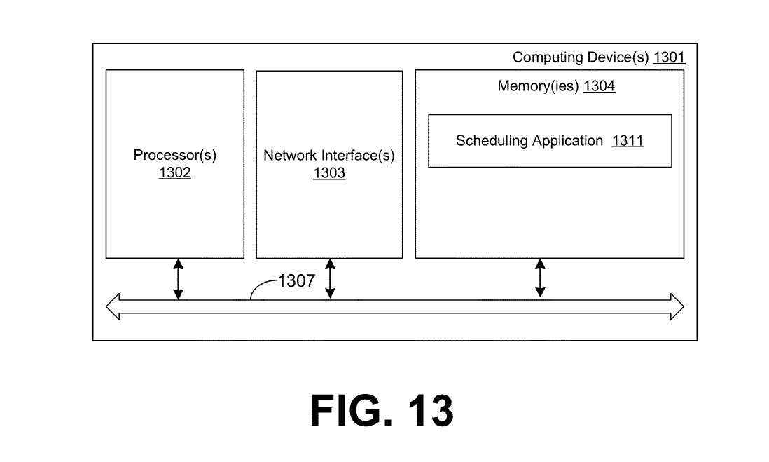

With reference to FIG. 13, shown is a schematic block diagram of a computing device 1301 according to various embodiments of the present disclosure. The computing device 1301 includes at least one processor circuit, for example, having a processor 1302, a memory 1304, and a network interface 1303, each of which is coupled to a local interface 1307. To this end, the computing device 1301 may comprise, for example, at least one server computer or like device. The local interface 1307 may comprise, for example, a data bus with an accompanying address/control bus or other bus structure as can be appreciated.

Stored in the memory 1304 are both data and several components that are executable by the processor 1302. In particular, stored in the memory 1304 and executable by the processor 1302 are a scheduling application 1311, and potentially other applications. Also stored in the memory 1304 may be a data store and other data. In addition, an operating system may be stored in the memory 1304 and executable by the processor 1302.

It is understood that there may be other applications that are stored in the memory 1304 and are executable by the processor 1302 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 1304 and are executable by the processor 1302. In this respect, the term “executable” means a program file that is in a form that can ultimately be run by the processor 1302. Examples of executable programs may be, for example, a compiled program that can be translated into machine code in a format that can be loaded into a random access portion of the memory 1304 and run by the processor 1302, source code that may be expressed in proper format such as object code that is capable of being loaded into a random access portion of the memory 1304 and executed by the processor 1302, or source code that may be interpreted by another executable program to generate instructions in a random access portion of the memory 1304 to be executed by the processor 1302, etc. An executable program may be stored in any portion or component of the memory 1304 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1304 is defined herein as including both volatile and nonvolatile memory and data storage components. Volatile components are those that do not retain data values upon loss of power. Nonvolatile components are those that retain data upon a loss of power. Thus, the memory 1304 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1302 may represent multiple processors 1302 and/or multiple processor cores and the memory 1304 may represent multiple memories 1304 that operate in parallel processing circuits, respectively. In such a case, the local interface 1307 may be an appropriate network that facilitates communication between any two of the multiple processors 1302, between any processor 1302 and any of the memories 1304, or between any two of the memories 1304, etc. The local interface 1307 may comprise additional systems designed to coordinate this communication, including, for example, performing load balancing. The processor 1302 may be of electrical or of some other available construction.

Although the scheduling application, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 1, and the user interfaces of FIGS. 2-12, show the functionality and operation of an implementation of portions of the scheduling application. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 1302 in a computer system or other system. The machine code may be converted from the source code, etc. If embodied in hardware, each block may represent a circuit or a number of interconnected circuits to implement the specified logical function(s).

Although the flowchart of FIG. 1, and the user interfaces of FIGS. 2-12, show a specific order of execution, it is understood that the order of execution may differ from that which is depicted. For example, the order of execution of two or more blocks may be scrambled relative to the order shown. Also, two or more blocks shown in succession may be executed concurrently or with partial concurrence. Further, in some embodiments, one or more of the blocks shown may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the scheduling application, that comprises software or code can be embodied in any non-transitory computer-readable medium for use by or in connection with an instruction execution system such as, for example, a processor 1302 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the scheduling application, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 1301 or in multiple computing devices in the same computing environment. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising at least one computing device, configured to at least:
a computing device; and
a scheduling application executed in the computing device, the scheduling application comprising:
logic that determines, based at least in part on a query applied to a calendar of a calendar provider of a user of the client device, at least one period of availability for the user;
logic that obtains a selection of at least one invitee;
logic that communicates a meeting request to the at least one invitee based at least in part on the period of availability, the meeting request comprising a meeting duration and at least one temporal parameter defining one or more time windows for a meeting to be held;
logic that determines a meeting time based at least in part on at least one response to the meeting request; and
wherein the at least one invitee is associated with another calendar provider distinct from the calendar provider of the user.

2. The system of claim 1, wherein the scheduling application further comprises:
logic that determines, after the selection of the at least one invitee, whether the at least one invitee is associated with a membership status; and
logic that, responsive to the at least one invitee not being associated with the membership, communicates, to the at least one invitee, at least one of a solicitation to obtain the scheduling application or a solicitation to register for the membership status.

3. The system of claim 1, wherein the query comprises at least one of a start date, an end date, a time window within one or more days, or a period of consecutive availability.

4. The system of claim 1, wherein the scheduling application further comprises logic that determines the query based at least in part on at least one of a selection of the query from a plurality of queries or a user input defining the query.

5. The system of claim 1, wherein the scheduling application further comprises logic that enforces a restriction of the at least one invitee according to a relationship model.

6. The system of claim 5, wherein the scheduling application further comprises logic that, responsive to the at least one invitee lacking a requisite relationship of the relationship model, communicates a solicitation to the at least one invitee to establish the requisite relationship.

7. The system of claim 5, wherein the relationship model comprises at least one of a contact list or a social media network.

8. The system of claim 1, wherein the logic that determines the at least one other period of availability comprises logic that obtains at least one period of availability from the at least one invitee according to an availability request communicated to the at least one invitee.

9. The system of claim 8, wherein the at least one other period of availability is filtered according to at least one user preference.

10. A method, comprising:
determining, by at least one computing device, based at least in part on a query applied to a calendar of a calendar provider of a user of the client device, at least one period of availability for the user;
obtaining, by the at least one computing device, a selection of at least one invitee;
communicating, by the at least one computing device, a meeting request to the at least one invitee based at least in part on the period of availability, the meeting request comprising a meeting duration and at least one temporal parameter defining one or more time windows for a meeting to be held;
determining, by the at least one computing device, a meeting time based at least in part on at least one response to the meeting request; and
wherein the at least one invitee is associated with another calendar provider distinct from the calendar provider of the user.

11. The method of claim 9, further comprising:
determining, by the at least one computing device, after the selection of the at least one invitee, whether the at least one invitee is associated with a membership status; and
responsive to the at least one invitee not being associated with the membership, communicating, by the at least one computing device, to the at least one invitee, at least one of a solicitation to obtain the scheduling application or a solicitation to register for the membership status.

12. The method of claim 9, wherein the query comprises at least one of a start date, an end date, a time window within one or more days, or a period of consecutive availability.

13. The method of claim 9, further comprising determining, by the at least one computing device, the query based at least in part on at least one of a selection of the query from a plurality of queries or a user input defining the query.

14. The method of claim 9, further comprising enforcing, by the at least one computing device, a restriction of the at least one invitee according to a relationship model.

15. The method of claim 14, further comprising communicating, by the at least one computing device, responsive to the at least one invitee lacking a requisite relationship of the relationship model, a solicitation to the at least one invitee to establish the requisite relationship.

16. The method of claim 14, wherein the relationship model comprises at least one of a contact list or a social media network.

17. The method of claim 9, wherein determining the at least one other period of availability obtaining, by the at least one computing device, at least one period of availability from the at least one invitee according to an availability request communicated to the at least one invitee.

18. The method of claim 16, wherein the at least one other period of availability is filtered according to at least one user preference.

19. A non-transitory computer-readable medium comprising a program executable by a computing device that, upon execution, causes the computing device to perform a method comprising:
determining, by at least one computing device, based at least in part on a query applied to a calendar of a calendar provider of a user of the client device, at least one period of availability for the user;
obtaining, by the at least one computing device, a selection of at least one invitee;
communicating, by the at least one computing device, a meeting request to the at least one invitee based at least in part on the period of availability, the meeting request comprising a meeting duration and at least one temporal parameter defining one or more time windows for a meeting to be held;
determining, by the at least one computing device, a meeting time based at least in part on at least one response to the meeting request; and
wherein the at least one invitee is associated with another calendar provider distinct from the calendar provider of the user.

20. The non-transitory computer-readable medium of claim 19, the method further comprising:
determining, after the selection of the at least one invitee, whether the at least one invitee is associated with a membership status; and
responsive to the at least one invitee not being associated with the membership, communicating, to the at least one invitee, at least one of a solicitation to obtain the scheduling application or a solicitation to register for the membership status.
